(19) United States
(12) Patent Application Publication
(10) Pub. No.: US 2006/0109525 A1
(43) Pub. Date: May 25, 2006

(54) Scanning non-flat objects with a 2-D CMOS/CCD sensor

(76) Inventor: Charles Edward Evans, Corvallis, OR (US)

Correspondence Address: AVAGO TECHNOLOGIES, LTD., P.O. BOX 1920, DENVER, CO, 80201-1920, US

(21) Appl. No.: 10/991,827

(22) Filed: Nov. 19, 2004

(51) Int. Cl. H04N 1/04

(52) U.S. Cl. 358/483

(57) ABSTRACT

An apparatus for scanning non-flat objects. The apparatus includes a sensor scanning a non-flat object to thereby produce a real-time preview of an image of the object, the sensor being a 2-D CMOS sensor or a 2-D CCD sensor, followed by a final scan of the non-flat object. The apparatus further includes a controller controlling a tilting angle and a height of the sensor with respect to the object in accordance with adjustments by a user viewing the preview of the image. The apparatus captures the image with the tilting angle and height controlled sensor.

### BACKGROUND OF THE INVENTION

1. Field of the Invention

The present invention relates to scanning non-flat objects. More particularly, the present invention relates to an apparatus and method for scanning non-flat objects using a two-dimensional (2-D) Complementary Metal Oxide Semiconductor (CMOS) or 2-D Charge-coupled Device (CCD) sensor.

2. Description of the Related Art

Many conventional scanners scan documents using a one-dimensional (1-D) CCD or a 1-D Contact Image Sensor (CIS) to capture images of the documents. In both of these types of sensors, the documents are scanned one line width at a time. By doing so, the conventional scanner provides high resolution for flat documents, however the speed is limited by the rate at which the 1-D CCD sensor or 1-D CIS sensor can capture data as well as the rate at which the data can be clocked out of the sensor.

Moreover, when using a conventional scanner to scan non-flat objects, the desired image of the non-flat object is often heavily distorted or unsuccessfully captured. For example, if a user-defined target is text located near a crease of a book, and the book will not lie flat on a receiving portion of the scanner, the text may be heavily distorted or completely missed. In addition, the resolution of the desired image may be very low.

Therefore, it is necessary to provide an apparatus capable of scanning non-flat objects at a higher speed and which provides better image quality of non-flat objects.

### SUMMARY OF THE INVENTION

Accordingly, it is an aspect of the present invention to provide an apparatus capable of scanning non-flat objects using 2-D CMOS or 2-D CCD sensors.

Additional aspects and advantages of the invention will be set forth in part in the description which follows, and, in part, will be obvious from the description, or may be learned by practice of the invention.

Aspects of the present invention are achieved by providing an apparatus including a sensor scanning a non-flat object to thereby produce a real-time preview of an image of the object, the sensor being a 2-D CMOS sensor or a 2-D CCD sensor. The apparatus further including a controller controlling a tilting angle and a height of the sensor with respect to the object in accordance with adjustments by a user viewing the preview of the image. The apparatus captures the image with the tilting angle and height controlled sensor.

Aspects of the present invention are further achieved by providing an apparatus including a first sensor scanning a first portion of the non-flat object to thereby produce a real-time preview of an image of the first portion of the non-flat object, and a second sensor positioned relative to the first sensor scanning a remaining portion of the non-flat object to thereby produce a real-time preview of an image of the remaining portion of the non-flat object. The first and second sensors are 2-D CMOS sensors or 2-D CCD sensors. The apparatus further including a controller controlling a tilting angle and a height of the first and second sensors with respect to the first and the remaining portions of the non-flat object respectively, in accordance with adjustments made by a user while viewing the previews of the images of the first and remaining portions of the non-flat object, wherein the apparatus captures the images of the first and remaining portions of the non-flat object with the adjustments.

Aspects of the present invention are further achieved by providing a method including (a) positioning a non-flat object, while viewing a real-time preview of an image of the non-flat object via a display; (b) adjusting zoom characteristics of the image via the display; and (c) capturing the image with the adjusted zoom characteristics via a sensor, the sensor being a 2-D CMOS sensor or a 2-D CCD sensor.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a diagram illustrating a scanning device having a 2-D CMOS or a 2-D CCD sensor, according to an embodiment of the present invention;

FIG. 2 is a diagram illustrating a scanning device having a tilting device and a 2-D CMOS or a 2-D CCD sensor, according to an embodiment of the present invention;

FIG. 3 is a diagram illustrating a scanning device having two 2-D CMOS sensors or 2-D CCD sensors, according to another embodiment of the present invention;

FIG. 4 is a diagram illustrating components of a scanning device, according to an embodiment of the present invention;

FIG. 5 is a flow chart illustrating of a process of scanning a non-flat object using the scanning device, according to an embodiment of the present invention; and

FIG. 6 is a flow chart illustrating a detailed process of scanning a non-flat object using a scanning device, according to an embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

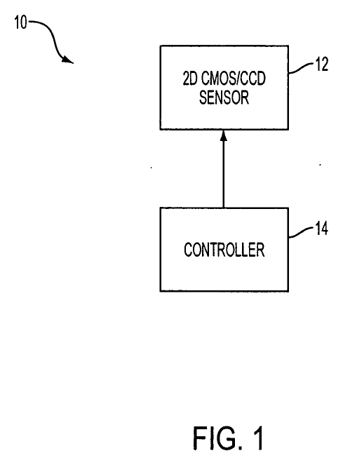

FIG. 1 is a diagram illustrating a scanning device having a 2-D CMOS or a 2-D CCD sensor (hereinafter referred to in the specification as a “2-D CMOS/CCD sensor”), according to an embodiment of the present invention. Referring now to FIG. 1, the scanning device 10 comprises a 2-D CMOS/CCD sensor 12 scanning a non-flat object (not shown) to thereby produce a real-time preview of an image of the non-flat object. The scanning device 10 further comprises a controller 14 controlling a tilting angle and a height of the 2-D CMOS/CCD sensor 12 with respect to the non-flat object in accordance with adjustments by a user viewing the preview of the image. Therefore, full resolution can be utilized by focusing the 2-D CMOS/CCD sensor 12 on a user-defined target. For example, if a user selects to scan only a portion of a page in a book, that area will use the full capacity of the 2-D CMOS/CCD sensor 12, thereby giving a greater resolution.

The scanning device 10 captures the image with the tilting angle and height controlled 2-D CMOS/CCD sensor 12. By using the 2-D CMOS/CCD sensor, the image of the object is instantaneously captured unlike a conventional scanner which scans the image one line width at a time. That is, the image is instantaneously captured thereby increasing the processing speed of the scanning device 10. The scanning device 10 may be, for example, a scanner or an all-in-one device including a scanner, printer, copier, etc. However, the present invention is not limited to the scanning device 10 including any of these particular features. The controller 14 may be implemented by sharing an existing CPU and dedicated firmware, or a dedicated processor may be utilized.

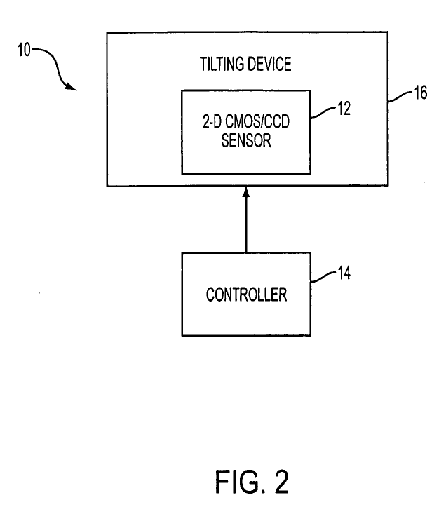

FIG. 2 is a diagram illustrating a scanning device having a tilting device and a 2-D CMOS/CCD sensor, according to an embodiment of the present invention. Now referring to FIG. 2, the scanning device 10 further comprises the tilting device 16 to house the 2-D CMOS/CCD sensor 12, wherein the controller 14 controls tilting and height adjustments of the 2-D CMOS/CCD sensor 12 in the tilting device 16. The tilting device includes mechanical components (not shown) to enable it to move the 2-D CMOS/CCD sensor 12 in a direction necessary to capture the real-time image as controlled by the controller 14.

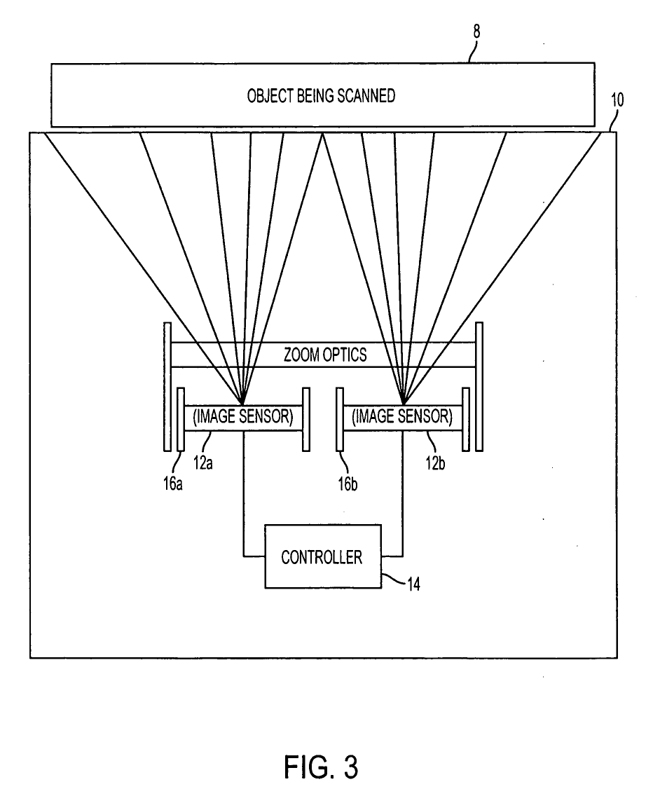

FIG. 3 is a diagram illustrating a scanning device having two 2-D CMOS/CCD sensors and two tilting devices, according to another embodiment of the present invention. Now referring to FIG. 3, the scanning device 10 comprises two 2-D CMOS/CCD sensors 12a and 12b and two tilting devices 16a and 16b to house the 2-D CMOS/CCD sensors 12a and 12b, respectively. A controller 14 controls the tilting and height adjustments of the 2-D CMOS/CCD sensors 12a and 12b in the tilting devices 16a and 16b. The scanning device 10 thereby captures an image of a first portion of a non-flat object 8 using the tilting and height controlled 2-D CMOS/CCD sensor 12a and an image of a remaining portion of the non-flat object 8 using the titling and height controlled 2-D CMOS/CCD sensor 12b. Depending upon the memory of the configuration and the application, each sensor 12a and 12b may be controlled by the controller 14 controlling a tilting angle and a height of sensors 12a and 12b respectively, or the controller 14 may control a tilting angle and height of both of the sensors 12a and 12b simultaneously.

The embodiment of the present invention as shown in FIG. 2 illustrates the use of one 2-D CMOS/CCD sensor 12 in the scanning device 10, and the embodiment of the present invention as shown in FIG. 3 illustrates the use of two 2-D CMOS/CCD sensors 12a and 12b in the scanning device 10. However, the present invention is not limited to the use of any specific number of 2-D CMOS/CCD sensors or any specific type of adjustment hardware.

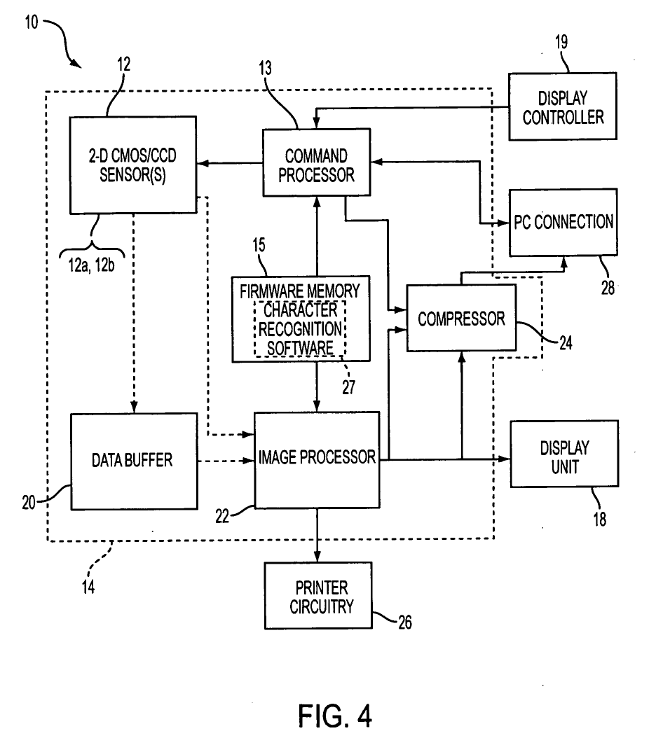

FIG. 4 is a diagram illustrating components of a scanning device according to an embodiment of the present invention. Now referring to FIG. 4, the scanning device 10 further comprises a display unit 18 to allow a user to view the real-time preview of the image while the user adjusts a position of a non-flat object (not shown in FIG. 4) and zoom characteristics of the image via the display unit 18. A display controller 19 controls the display unit 18 to thereby enable a user to adjust the position of the non-flat object and zoom characteristics of the image shown on the display unit 18 in real-time. The scanning device 10 further comprises a command processor 13 to receive instructions from the display controller 19 through the display unit 18, and firmware memory 15 to store the instructions required for operation of the scanning device 10 which are received by the command processor 13. Data buffer 20 may be provided to temporarily store image data corresponding to the image captured by the 2-D CMOS/CCD sensor 12, thereby enabling the 2-D CMOS/CCD sensor 12 to scan another non-flat object. An image processor 22 is also provided to process the image data stored in the data buffer 20. The image processor 22, firmware memory 15, data buffer 20 are well-known in the art.

The display unit 18 may be an LCD display or any other type of suitable display.

Printer circuitry 26 may be provided to print the captured image, wherein the stored image data is transferred to the printer circuitry 26 to print the captured image. The printer circuitry 26 is not limited to any specific type of printer.

The scanning device 10 may be connected to a computer system (not shown) through a PC connection 28, wherein the stored image data corresponding to the captured image is transferred to the computer system. The PC connection 28 may be a USB connection or any other type of interface that is well-known to one skilled in the art. However, the present invention is not limited to the connection being a “PC” connection or the computer system being a “PC”.

The image processor 22 may transfer the stored image data to a compressor 24 to thereby compress the stored image data into a format to be read by the computer system prior to transferring the stored image data to the computer system. The compressor 24 may compress the stored image data into for example, a JPEG format. However, the format is not limited to any particular type and may be any format readable by the computer system.

The firmware memory 15 may further be provided with a character recognition program 27 to enable the scanning device 10 to scan full-page text documents.

As an alternative to using the data buffer 20, the scanning device 10 may comprise first and second 2-D CMOS/CCD sensors 12a and 12b to respectively scan a first and a second portion of a non-flat object(s) to thereby capture the image of each of the first and second portions of the non-flat object(s), wherein the images captured by the first and second 2-D CMOS/CCD sensors may be combined into one image by the image processor 22. The combining of multiple images into one image by an image processor is a process that is well-known to one skilled in the art.

As shown in FIG. 4, the controller 14 may include 2-D CMOS/CCD Sensor 12 or 2-D CMOS/CCD sensors 12a and 12b, command processor 13, firmware memory 15, data buffer 20, image processor 22 and compressor 24. However, the controller 14 is not limited to this arrangement, and thus the arrangement may be varied to exclude any one these components.

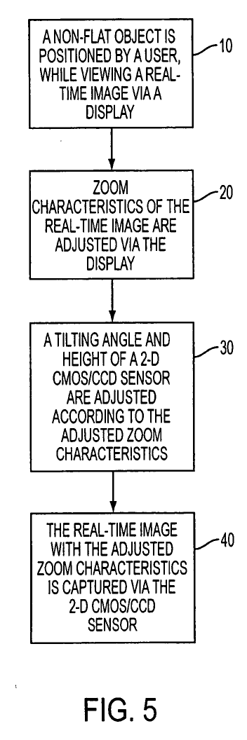

FIG. 5 is a flowchart illustrating a process of scanning a non-flat object using a scanning device, according to an embodiment of the present invention. Now referring to FIG. 5, in operation 10, a non-flat object is positioned by a user, while the user views a real-time image of the non-flat object via a display.

From operation 10, the process moves to operation 20, where zoom characteristics of the real-time image are adjusted via the display.

From operation 20, the process moves to operation 30, where a tilting angle and height of a 2-D CMOS/CCD sensor are adjusted according to the adjusted zoom characteristics.

From operation 30, the process moves to operation 40, where the real-time image with the adjusted zoom characteristics is captured via the 2-D CMOS/CCD sensor.

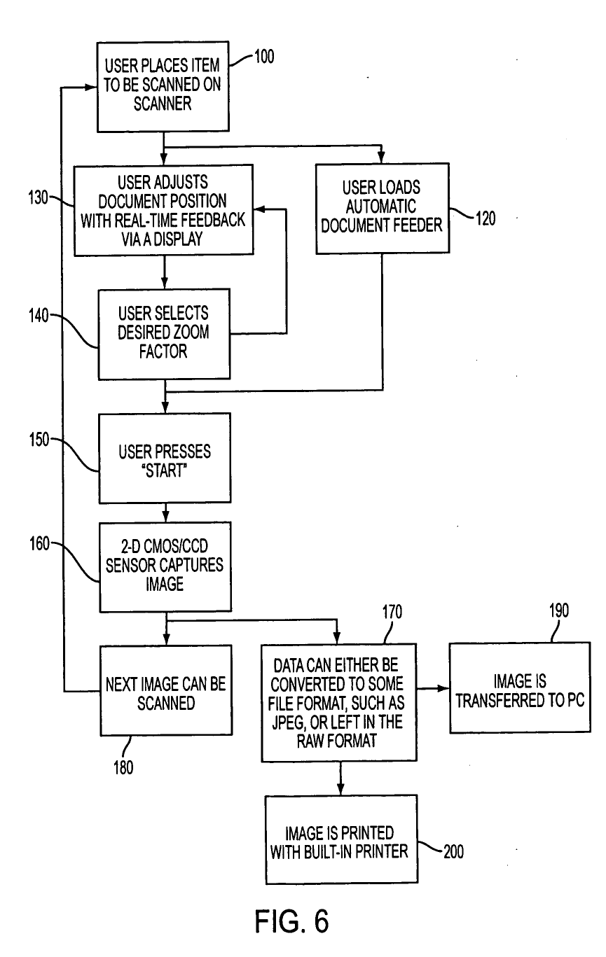

FIG. 6 is a flow chart illustrating a detailed process of scanning a non-flat object using a scanning device, according to an embodiment of the present invention. Now referring to FIG. 6, in operation 100, a user places an item to be scanned on a scanning device.

From operation 100, the process moves to operation 130, where the user adjusts the document position with real-time feedback via a display.

From operation 130, the process moves to operation 140, where the user selects desired zoom factor of an image being shown on the display in real-time.

From operation 140, the process moves to operation 150, where the user presses start. From operation 140, the process may move back to operation 130, where the user can adjusts the document position with real-time feedback via the display.

As an alternative from operation 100, in operation 120, the user may load a document on an automatic document feeder. From operation 120, the process then moves to operation 150, where the user presses start to start the scanning process.

From operation 150, the process moves to operation 160, where the 2-D CMOS/CCD sensor(s) capture the image of the non-flat object in accordance with the adjustments made by the user. The tilting angle and height of the 2-D CMOS/CCD sensor(s) are adjusted in accordance with the adjustments made by the user prior to capturing the image of the non-flat object with the adjusted zoom characteristics.

From operation 160, the process moves to operation 170, where image data corresponding to the captured image can be either converted to some file format, such as JPEG, or left in raw format.

From operation 160, the process moves to operation 180, where a next image can be scanned by the 2-D CMOS/CCD sensor(s) after the image data is transferred to an image processor or data buffer. From operation 180, the process returns to operation 100.

From operation 170, the process may move to operation 190, where the image is transferred to a computer system.

As an alternative, from operation 170, the process may move to operation 200, where the image is printed using a built-in printer.

FIGS. 5 and 6 show various operations of the scanning device being performed. However, the present invention is not limited to a particular order of the operations. Instead, the order of operations can be varied. In addition, the present invention is not limited to all these operations being performed and some of the operations can be eliminated. Also it is understood that these operations can be implemented using computer software, including firmware, readable by a computer.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus comprising:
a sensor scanning a non-flat object to thereby produce a real-time preview of an image of the object, the sensor being a 2-D CMOS sensor or a 2-D CCD sensor; and
a controller controlling a tilting angle and a height of the sensor with respect to the object in accordance with adjustments by a user viewing the preview of the image, wherein the apparatus captures the image with the tilting angle and height controlled sensor.

2. The apparatus of claim 1, further comprising:
a tilting device to house the sensor, wherein the controller controls tilting and height adjustments of the sensor in the tilting device.

3. The apparatus of claim 2, further comprising a display unit to allow a user to view the preview of the image in real-time while the user adjusts a position of the non-flat object and zoom characteristics of the image via the display unit.

4. The apparatus of claim 1, further comprising data buffers to temporarily store image data corresponding to the captured image, thereby enabling the sensor to scan another non-flat object.

5. The apparatus of claim 4, further comprising a built-in printer to print the captured image, wherein the stored image data is transferred to the built-in printer to print the captured image.

6. The apparatus of claim 4, wherein the apparatus is connected to a computer system and the stored image data corresponding to the captured image is transferred to the computer system.

7. The apparatus of claim 1, further comprising a character recognition program to enable the apparatus to scan full-page text documents.

8. An apparatus comprising:
a first sensor scanning a first portion of a non-flat object to thereby produce a real-time preview of an image of the first portion of the non-flat object;
a second sensor positioned relative to the first sensor scanning a remaining portion of the non-flat object to thereby produce a real-time preview of an image of the remaining portion of the non-flat object, the first and second sensors being 2-D CMOS sensors or 2-D CCD sensors; and
a controller controlling a tilting angle and a height of the first and second sensors with respect to the first and the remaining portions of the non-flat object respectively, in accordance with adjustments made by a user while viewing the previews of the images of the first and remaining portions of the non-flat object, wherein the apparatus captures the images of the first and remaining portions of the non-flat object with the adjustments.

9. The apparatus of claim 8, further comprising an image processor, wherein the images captured by the first and second sensors are combined into one image by the image processor.

10. A method comprising:
positioning a non-flat object, while viewing a real-time preview of an image of the non-flat object via a display;
adjusting zoom characteristics of the image via the display; and
capturing the image with the adjusted zoom characteristics via a sensor, the sensor being a 2-D CMOS sensor or a 2-D CCD sensor.

11. The method of claim 10, wherein the capturing the image of the non-flat object via the sensor comprises adjusting a tilting angle and height of the sensor prior to capturing the image.

12. The method of claim 10, further comprises:
storing image data corresponding to the captured image in data buffers;
processing the stored image data; and
printing the captured image of the non-flat object.

13. An apparatus comprising:
a sensor scanning a non-flat object to thereby produce a real-time preview of an image of the object, the sensor being a 2-D CMOS sensor or a 2-D CCD sensor; and
means for controlling a tilting angle and a height of the sensor with respect to the object in accordance with adjustments by a user viewing the preview of the image, wherein the apparatus captures the image with the tilting angle and height controlled sensor.

14. An apparatus comprising:
a first sensor scanning a first portion of a non-flat object to thereby produce a real-time preview of an image of the first portion of the non-flat object;
a second sensor positioned relative to the first sensor scanning a second portion of the non-flat object to thereby produce a real-time preview of an image of the second portion of the non-flat object, the first and second sensors being 2-D CMOS sensors and 2-D CCD sensors, wherein a scanning process of the first and second sensors are completed consecutively or simultaneously; and
means for controlling a tilting angle and a height of the first and second sensors with respect to the first and second portions of the non-flat object respectively, in accordance with adjustments made by a user while viewing the real-time previews of the images of the first and second portions of the non-flat object, wherein the apparatus captures the images of the first and second non-flat objects with adjustments, consecutively or simultaneously.
